(19) United States
(12) Patent Application Publication
(10) Pub. No.: US 2021/0138518 A1
(43) Pub. Date: May 13, 2021

(54) Duct cleaning apparatus

(71) Applicant: Oy Lifa Air Ltd, Helsinki (FI)

(72) Inventors: Johan Brandt, Helsinki (FI); Kauko Salomäki, Helsinki (US)

(21) Appl. No.: 17/052,212

(22) PCT Filed: May 2, 2019
(86) PCT No.: PCT/FI2019/050344

§ 371 Date: Nov. 2, 2020

(30) Foreign Application Priority Data
May 2, 2018 (FI) 20185403

(51) Int. Cl. B08B 9/045; E03F 9/00

(52) U.S. Cl. CPC B08B 9/045; B08B 9/047; E03F 9/005

(57) ABSTRACT

According to an example aspect of the present invention, there is provided a duct cleaning apparatus comprising a frame, a coil carriage which is coupled to the frame and configured to rotate around an axis of rotation, a shaft with a first end and a second end, wherein the shaft is configured to rotate within a guide wire cable, a cleaning tool which is connected to the shaft at the first end of the shaft, a drive unit coupled to the second end of the shaft via a gear, and wherein the drive unit, the gear, control electronics and at least one battery are located within the coil carriage.

### FIELD

The present invention relates to a duct cleaning apparatus.

Additionally, the present invention relates to a method of operating a duct cleaning apparatus.

### BACKGROUND

Duct cleaning apparatuses which comprise a brush at an end of a long cable or shaft configured to be inserted into the duct to be cleaned are known. The brush is moved inside the duct and for enhanced cleaning effect it is rotated or caused to make jerking movements. The rotational or jerking movement of the brush is achieved either by an electric, pneumatic or hydraulic drive, whereby the drive is connected to the brush and drive force is transmitted to a motor along the guide wire cable by means of electric lines, pneumatic pressure lines or hydraulic pressure lines. Solutions are also known where a flexible shaft rotates inside the guide wire cable, whereby the motor generating the drive force is situated at the opposite end of the guide wire cable with regard to the brush.

For example, document WO 2001/038016 A1 discloses an arrangement for cleaning ducts and chimneys, such as air-conditioning ducts. The arrangement comprises a guide wire cable having a cleaning end and a feed end, a brush or some other tool being connected to the cleaning end of the guide wire cable, and a drive unit connected to the feed end of the guide wire cable. The arrangement further comprises transmission means for moving the brush by means of the drive unit. The drive unit comprises a hydraulic pump, the transmission means are provided by hydraulic pipes arranged inside the guide wire cable. The primary drive unit for the brush is a hydraulic motor connected to the cleaning end of the guide wire cable.

An electrically operated duct cleaning apparatus is known from the website “Lifa Air SpecialCleaner 20”, viewed on Mar. 15, 2018. The duct cleaning apparatus comprises a frame to which an electric motor is attached. A first T-gear is coupled to the motor. The electric motor and the first T-gear are coupled to the frame and arranged outside of a so called drum or coil carriage. A transmission shaft is connected to the first T-gear. The transmission shaft serves as a rotating axis of the coil carriage. A second T-gear is coupled to the transmission shaft. Further, a 20 m long rotating shaft is coupled to the second T-gear at a first end of the shaft. The flexible shaft rotates inside a guide wire cable. The brush for cleaning the duct is coupled to the rotating shaft at its second end.

In view of the foregoing, it would be beneficial to provide a more compact duct cleaning apparatus comprising a rotating shaft within a guide wire cable.

### SUMMARY OF THE INVENTION

The invention is defined by the features of the independent claims. Some specific embodiments are defined in the dependent claims.

According to a first aspect of the present invention, there is provided a duct cleaning apparatus comprising a frame, a coil carriage which is coupled to the frame and configured to rotate around an axis of rotation, a shaft with a first end and a second end, wherein the shaft is configured to rotate within a guide wire cable, a cleaning tool which is connected to the shaft at the first end of the shaft, a drive unit coupled to the second end of the shaft via a gear, and wherein the drive unit, the gear, control electronics and at least one battery are located within the coil carriage.

Various embodiments of the first aspect may comprise at least one feature from the following bulleted list:
the at least one battery is removable
the drive unit, the gear, control electronics and the at least one battery are arranged to simultaneously rotate with the coil carriage around the axis of rotation
the apparatus comprises an external battery charger configured to charge the at least one battery
the at least one battery comprises a 12-48 V battery, for example a 24 V Lithium-Ion battery or Lithium-Oxide battery
the at least one battery is configured to provide energy required to rotate the shaft
the apparatus comprises a battery receiving unit configured to receive the at least one battery
the battery receiving unit is arranged within the coil carriage
the at least one battery is configured to be coupled to the battery receiving unit by a snap-like action
the at least one battery is configured to be decoupled from the battery receiving unit subsequent to unlocking the at least one battery
the at least one battery is electrically connected to the control electronics
the control electronics are configured to control the drive unit
the drive unit comprises a 12-48 V DC motor
the coil carriage is capable of receiving the shaft arranged within the guide wire cable

According to a second aspect of the present invention, there is provided a method of operating a duct cleaning apparatus, the method comprising providing electric energy required for rotating a shaft, to which a cleaning tool is coupled, by at least one battery, and rotating the shaft, which is connected to a drive unit via a gear, wherein the drive unit, the gear, control electronics and the at least one battery are located within a coil carriage.

Various embodiments of the second aspect may comprise at least one feature from the following bulleted list:
the coil carriage, the drive unit, the gear, the control electronics and the at least one battery are simultaneously rotated around an axis of rotation
the method further comprising coupling the at least one battery to a battery receiving unit by a snap-like action
the method further comprising decoupling the at least one battery from the battery receiving unit subsequent to unlocking the at least one battery
the method further comprising rolling-up the shaft arranged within a guide wire cable around the coil carriage.
a first battery is charged with an external charger while a second battery is being used to provide the electric energy required to drive the shaft with the driving unit

Considerable advantages are obtained by means of certain embodiments of the present invention. A duct cleaning apparatus and a method of operating a duct cleaning apparatus are provided. The drive unit is not attached to the frame of the duct cleaning apparatus anymore. Thus, the duct cleaning apparatus is very compact due to arranging the drive unit, the gear, the control electronics and the at least one battery within the coil carriage. All components required for rotating the shaft, and thus the cleaning tool, are located within the outer contours of the coil carriage. Consequently, the dimensions of the duct cleaning apparatus can be reduced.

Additionally, the duct cleaning apparatus does not have to be connected to a power socket via an electric cable anymore. Thus, the duct cleaning apparatus can be used at any desired location, because the electric energy required for driving the shaft with the drive unit is provided by the at least one battery. An electric energy network is not required at the desired location. In some countries, e.g. the UK, the safety regulations require electric tools connected to mains to be isolated from the electric network with isolation transformer. Battery operated systems make it redundant. It also makes it easier to operate the duct cleaning apparatus in various environments, since it operates within the safety Voltage range <48 V.

Further, the at least one battery can be quickly and easily coupled to a battery receiving unit arranged within the coil carriage, for example by a snap-like action. Of course, also decoupling of the at least one battery from the receiving unit can be carried out quickly and easily, for example subsequent to unlocking the at least one battery. Replacing of an empty battery with a fully loaded battery can be therefore carried out within a few seconds. According to certain embodiments, a first battery can be charged with an external charger while a second battery is being used to provide the electric energy required to drive the shaft with the driving unit. The duct cleaning apparatus can be used continuously by providing a plurality of batteries.

After use of the duct cleaning apparatus, the unit formed by the shaft and the guide wire cable can be quickly and easily rolled-up by simultaneously rotating the coil carriage, the drive unit, the gear, the control electronics and the at least one battery around the central axis of the coil carriage.

### BRIEF DESCRIPTION OF THE DRAWINGS

FIG. 1 illustrates a schematic side view of a duct cleaning apparatus in accordance with at least some embodiments of the present invention,

FIG. 2 illustrates a schematic cross sectional view of a unit formed of a shaft and a guide wire cable of a duct cleaning apparatus in accordance with at least some embodiments of the present invention, and

FIG. 3 illustrates a flowchart of a method of operating a duct cleaning apparatus in accordance with at least some embodiments of the present invention.

### EMBODIMENTS

In FIG. 1 a schematic side view of a duct cleaning apparatus 1 in accordance with at least some embodiments of the present invention is illustrated. The duct cleaning apparatus 1 comprises a frame 2 and a coil carriage 3 which is coupled to the frame 2 and configured to rotate around an axis of rotation 4 as indicated by arrow A. Typically, the coil carriage 3 is coupled to the frame 2 at the central axis of the coil carriage 3. The frame 2 normally comprises at least one vertical part on each side of the coil carriage 2, which parts are connected to each other.

The duct cleaning apparatus 1 further comprises a shaft 5 with a first end 6 and a second end 7. Typically, the shaft is arranged within a guide wire cable (not shown). The shaft 5 is configured to rotate within the guide wire cable as indicated by arrow B. The shaft may be, for example, 20 m long. On the one hand, the unit formed by the shaft 5 and the guide wire cable is flexible enough to be rolled-up on the coil carriage 3. On the other hand, the unit formed by the shaft 5 and the guide wire cable is so stiff that a user can select or control the position of a cleaning tool 8 when the cleaning tool 8 is inserted into a duct (not shown). The cleaning tool 8 is connected to the shaft 5 at a first end 6 of the shaft 5. The cleaning tool 8 may be, for example a brush comprising a plurality of bristles which extend radially outwards from a center body of the brush. The brush can be moved inside the duct to be cleaned and for enhanced cleaning effect the brush can be rotated or caused to make jerking movements.

Furthermore, the duct cleaning apparatus comprises a drive unit 9 coupled to the second end 7 of the shaft 5 via a gear 10. The drive unit 9 may, for example, comprise a 24 V DC motor. The gear 10 may be, for example, a T-gear. The drive unit 9, the gear 10, control electronics 11 and at least one battery 12 are located within the coil carriage 3. In other words, the aforementioned components are attached to the coil carriage 3 within the outer contours of the coil carriage 3 or within the volume formed by the outermost parts of the coil carriage 3. Consequently, the drive unit 9, the gear 10, the control electronics 11 and the at least one battery 12 simultaneously rotate with the coil carriage 3 around the axis of rotation 4 when the coil carriage 3 is rotated in order to roll-up the shaft 5 on the coil carriage 3 or to un-roll the shaft 5 from the coil carriage 3.

The at least one battery 12 is typically removable and can be charged by an external battery charger (not shown) comprised by the duct cleaning apparatus. The at least one battery 12 may be, for example, a 24 V Lithium-Ion battery. The at least one battery 12 is configured to provide energy required to rotate the shaft 5, and thus also the cleaning tool 8. Typically, the apparatus 1 comprises a battery receiving unit (not shown) configured to receive the at least one battery 12. The battery receiving unit is also arranged within the coil carriage 3. Normally, the at least one battery 12 is configured to be coupled to the battery receiving unit by a snap-like action and to be decoupled from the battery receiving unit subsequent to unlocking the at least one battery 12. With such a quick-lock-system it is possible to quickly and easily insert the at least one battery into the battery receiving unit and to quickly and easily remove the at least one battery from the battery receiving unit.

The at least one battery 12 is electrically connected to the control electronics 11 by an electric connection 17. The control electronics 11 are configured to control the drive unit 9, and thus also to control the rotation of the shaft 5 and the cleaning tool 8. Typical functions of the control electronics include starting of the rotation of the shaft 5, stopping the rotation of the shaft 5, and controlling the number of revolutions of the shaft in a specific period of time. According to certain embodiments, a user may select a predetermined operation mode, for example a first mode with a low number of revolutions of the shaft in a specific period of time or a second mode with a high number of revolutions of the shaft in a specific period of time. The predetermined operation mode may be, for example, activated by the user by pushing a respective button. According to certain other embodiments, a user may freely select the number of revolutions of the shaft in a specific period of time, for example by a rotary control switch or by two different buttons, i.e. one button for increasing the number of revolutions and one button for decreasing the number of revolutions. The buttons may be pushed by a user's foot, a user's hand or a user's fingers.

In the embodiment shown in FIG. 1, the frame 2 further comprises a support 16 and wheels 14 so that the duct cleaning apparatus can be positioned in an upright direction. The frame 2 of the duct cleaning apparatus 1 further comprises a handle 15. A user can move the duct cleaning apparatus 1 with the aid of the wheels 14 by inclining it such that the support 16 is not in contact with the surface of the ground and by pulling or pushing the apparatus 1.

In FIG. 2 a schematic cross sectional view of a unit formed of a shaft 5 and a guide wire cable 13 of a duct cleaning apparatus in accordance with at least some embodiments of the present invention is illustrated. It can be seen that the shaft 5 is arranged within the guide wire cable 13. The shaft 5 is configured to rotate within the guide wire cable 13. The rotational movement of a cleaning tool (not shown), for example a brush, is achieved by an electric drive unit (not shown). The shaft 5 is coupled to the cleaning tool at a first end of the shaft 5 and to the drive unit via a gear at a second end of the shaft 5. In other words, a flexible shaft 5 rotates inside the guide wire cable 13, whereby the motor generating the drive force is situated at the opposite end of the guide wire cable 13 with regard to the cleaning tool.

In FIG. 3 a flowchart of a method of operating a duct cleaning apparatus in accordance with at least some embodiments of the present invention is illustrated. The method comprises providing electric energy required for rotating a shaft, to which a cleaning tool is coupled, by at least one battery, and rotating the shaft, which is connected to a drive unit via a gear, wherein the drive unit, the gear, control electronics and the at least one battery are located within a coil carriage. In other words, different components of a duct cleaning apparatus, which components are necessary for rotating a flexible shaft, and thus also a cleaning tool, are provided inside the outer contours of a coil carriage. The energy required for rotating the shaft is provided by at least one battery. Due to the energy supply in the form of at least one battery, the method of operating the duct cleaning apparatus can be performed at any desired location. Connecting the duct cleaning apparatus and an electric network by an electric cable is not required anymore.

Typically, the shaft is rolled-up on the coil carriage after use of the duct cleaning apparatus and un-rolled from the coil carriage prior to use of the duct cleaning apparatus. When rolling-up or un-rolling the flexible shaft, the coil carriage, the drive unit, the gear, the control electronics and the at least one battery are simultaneously rotated around an axis of rotation. The axis of rotation is typically the central axis of the coil carriage.

According to certain embodiments, the at least one battery is coupled to a battery receiving unit, for example by a snap-like action. Thus, it is possible to quickly and easily connect the at least one battery to the duct cleaning apparatus. Decoupling of the at least one battery from the battery receiving unit can also be carried out quickly and easily subsequent to unlocking the at least one battery. Consequently, a first battery can be charged with an external charger while a second battery is being used to provide the electric energy required to drive the shaft with the driving unit. Replacing an empty battery by a fully loaded battery can typically be carried out within a few seconds. Thus, it is possible to continuously operate the duct cleaning apparatus at any desired location.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in cleaning of ducts or sewers.

### REFERENCE SIGNS LIST

1 duct cleaning apparatus
2 frame
3 coil carriage
4 axis of rotation
5 shaft
6 first end
7 second end
8 cleaning tool
9 drive unit
10 gear
11 control electronics
12 battery
13 wire cable
14 wheel
15 handle
16 support
17 electric connection
A arrow
B arrow

### CITATION LIST

### Patent Literature

WO 2001/038016 A1

### Non Patent Literature

Web Page “Lifa Air SpecialCleaner 20”

1. A duct cleaning apparatus comprising:
a frame,
a coil carriage which is coupled to the frame and configured to rotate around an axis of rotation,
a shaft with a first end and a second end, wherein the shaft is configured to rotate within a guide wire cable,
a cleaning tool which is connected to the shaft at the first end of the shaft, and
a drive unit coupled to the second end of the shaft via a gear, and wherein the drive unit, the gear, control electronics and at least one battery are located within the coil carriage, wherein the drive unit, the gear, control electronics and the at least one battery are arranged to simultaneously rotate with the coil carriage around the axis of rotation.

2. The duct cleaning apparatus according to claim 1, wherein the at least one battery is removable.

3. (canceled)

4. The duct cleaning apparatus according to claim 1, wherein the apparatus further comprises an external battery charger configured to charge the at least one battery.

5. The duct cleaning apparatus according to claim 1, wherein the at least one battery comprises a 12-48 V battery.

6. The duct cleaning apparatus according to claim 1, wherein the at least one battery is configured to provide energy required to rotate the shaft.

7. The duct cleaning apparatus according to claim 1, wherein the apparatus further comprises a battery receiving unit configured to receive the at least one battery.

8. The duct cleaning apparatus according to claim 7, wherein the at least one battery is configured to be coupled to the battery receiving unit by a snap-like action.

9. The duct cleaning apparatus according to claim 7, wherein the at least one battery is configured to be decoupled from the battery receiving unit subsequent to unlocking the at least one battery.

10. The duct cleaning apparatus according to claim 1, wherein the at least one battery is electrically connected to the control electronics.

11. The duct cleaning apparatus according to claim 1, wherein the control electronics are configured to control the drive unit.

12. The duct cleaning apparatus according to claim 1, wherein the drive unit comprises a 12-48 V DC motor.

13. The duct cleaning apparatus according to claim 1, wherein the gear comprises a T-gear.

14. A method of operating a duct cleaning apparatus, the method comprising:
providing electric energy required for rotating a shaft, to which a cleaning tool is coupled, by at least one battery,
rotating the shaft, which is connected to a drive unit via a gear, wherein the drive unit, the gear, control electronics and the at least one battery are located within a coil carriage, and
simultaneously rotating the coil carriage, the drive unit, the gear, the control electronics and the at least one battery around an axis of rotation.

15. (canceled)
